(19) United States
(12) Patent Application Publication
(10) Pub. No.: US 2025/0254555 A1
(43) Pub. Date: Aug. 7, 2025

(54) TECHNOLOGIES FOR CROSS-LINK INTERFERENCE MANAGEMENT

(71) Applicant: Apple Inc., Cupertino, CA (US)

(72) Inventors: Haitong Sun, Saratoga, CA (US); Oghenekome Oteri, San Diego, CA (US); Ankit Bhamri, Haar Bavaria-Bayern (DE); Dawei Zhang, Saratoga, CA (US); Wei Zeng, Saratoga, CA (US); Seyed Ali Akbar Fakoorian, San Diego, CA (US); Dan Wu, Beijing (CN)

(73) Assignee: Apple Inc., Cupertino, CA (US)

(21) Appl. No.: 19/006,549

(22) Filed: Dec. 31, 2024

Related U.S. Application Data
(60) Provisional application No. 63/549,362, filed on Feb. 2, 2024.

(51) Int. Cl. H04W 24/10; H04L 5/00

(52) U.S. Cl. CPC H04W 24/10; H04L 5/0057; H04L 5/0085; H04L 5/0094

(57) ABSTRACT

The present application relates to devices and components including apparatus, systems, and methods for supporting layer 1 cross-link interference measurement and reporting.

### CROSS-REFERENCES TO OTHER APPLICATIONS

This application claims priority to U.S. Provisional Application No. 63/549,362, for “TECHNOLOGIES FOR CROSS-LINK INTERFERENCE MANAGEMENT” filed on Feb. 2, 2024, which is herein incorporated by reference in its entirety for all purposes.

### TECHNICAL FIELD

This application relates generally to communication networks and, in particular, to technologies for layer 1 cross-link interference management.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates a signaling diagram in accordance with some embodiments.

FIG. 4 illustrates a signaling diagram in accordance with some embodiments.

FIG. 5 illustrates resource and report configurations in accordance with some embodiments.

FIG. 6 illustrates a report configuration in accordance with some embodiments.

FIG. 7 illustrates a resource configuration in accordance with some embodiments.

FIG. 8 illustrates a report configuration in accordance with some embodiments.

FIG. 9 illustrates processing and reporting in accordance with some embodiments.

FIG. 10 illustrates an operation flow/algorithmic structure in accordance with some embodiments.

FIG. 11 illustrates another operation flow/algorithmic structure in accordance with some embodiments.

FIG. 12 illustrates another operation flow/algorithmic structure in accordance with some embodiments.

FIG. 13 illustrates a user equipment in accordance with some embodiments.

FIG. 14 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects, or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

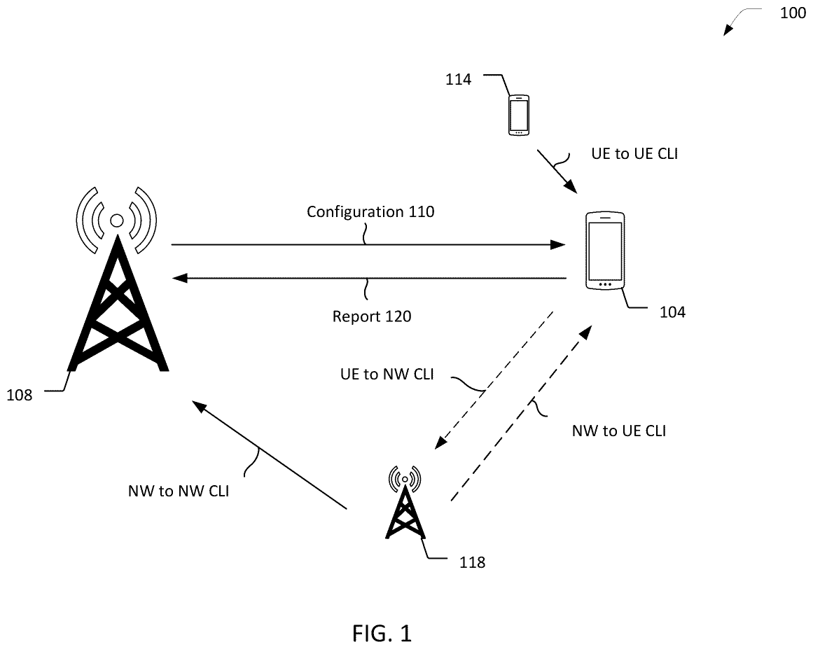

FIG. 1 illustrates a network environment 100 in accordance with some embodiments. The network environment 100 may include user equipment (UEs) 104/114 communicatively coupled with base stations 108/118 of a radio access network (RAN). The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The network (NW) may configure a carrier frequency, denoted by F1, for downlink (DL) transmissions, e.g., from the base station 108 to the UE 104. The network may also configure a carrier frequency, denoted by F2, for uplink (UL) transmissions, e.g., from the UE 104 to the base station 108. In a frequency division duplex (FDD), the UL carrier is different from the DL carrier, e.g., F1 is not the same as F2, whereas for time division duplex (TDD), the UL and DL carriers are the same, e.g., F1 is the same as F2. The carrier frequencies F1 and F2 in FDD operation may be called a paired spectrum, and the carrier frequency F1 in TDD operation may be called an unpaired spectrum.

The network nodes, e.g., the base stations 108/118 or the UE 104/114, may be capable of performing half-duplex or full-duplex operations. In half-duplex operation, the network node performs one of the transmission or reception operations at a given time. For example, when the base station 108/118 performs half-duplex DL transmission, it may not perform the UL reception, or when the base station 108 performs half-duplex UL reception, it may not perform the DL transmission. Similarly, when the UE 104 performs half-duplex UL transmission, it may not perform the DL reception, or when the UE 104 performs half-duplex DL reception, it may not perform the UL transmission.

In another example, when the base station 108 performs full-duplex DL transmission, it may perform the UL reception concurrently with the DL transmission. Similarly, when the UE 104 performs full-duplex UL transmission, it may perform DL reception concurrently with the UL transmission.

The base stations 108/118 or the UEs 104/114 may perform sub-band full duplex (SBFD). For example, the base station 108, capable of SBFD operation, may simultaneously receive a UL transmission from one UE, e.g., UE 104, and perform a DL transmission to another UE, e.g., UE 114. In an SBFD operation, a frequency gap may be provisioned between the DL and UL frequencies.

Cross-link interference (CLI) may exist in a full-duplex operation or SBFD in an unpaired spectrum, e.g., TDD. For example, the UL transmission of the UE 114 may interfere with the UE 104 reception of the base station 108 DL transmission. Cross-link interference between the transmission of one UE, e.g., UE 114, and the reception of another UE, e.g., UE 104, may be called UE-to-UE CLI.

In another example, the downlink transmission of base station 118 may interfere with the reception of base station 108 of the UE 104 UL transmission. Cross-link interference between the transmission of one base station, e.g., base station 118, and the reception of another base station, e.g., base station 108, may be called NW-to-NW CLI.

The interference may cause degradation in receiver performance, such as an increase in error rate, which may reduce throughput or the reliability of the communication link between the transmitter and the receiver. Therefore, it is desirable to manage the CLI, such as UE-to-UE or NW-to-NW CLI. In a legacy solution, the UE may be configured to perform a layer 3 (L3), e.g., radio resource control (RRC) layer, CLI measurement, and reporting. However, L3 measurement and reporting may be associated with large delay or latency. A layer 1 (L1), e.g., physical layer, measurement, and reporting, may enable the system to address the degradation caused by CLI.

In some embodiments, the base station 108 may send a configuration 110 to the UE 104. Configuration 110 may configure the UE 104 to perform measurements associated with UE-to-UE CLI and generate a report 120. The UE 104 may send the report 120 to the base station 104. Base station 108 may use the information provided by the report 120 in scheduling UEs, allocating network resources, or coordinating with other network elements, e.g., base station 118.

In some instances, configuration 110 may configure resources that UE 104 may use to perform measurements associated with the UE-to-UE CLI. Configuration 110 may include information elements (IEs) to allocate resources for measuring and reporting CLI. For example, the IE associated with channel state information (CSI) may include fields to configure CLI measurement and reporting.

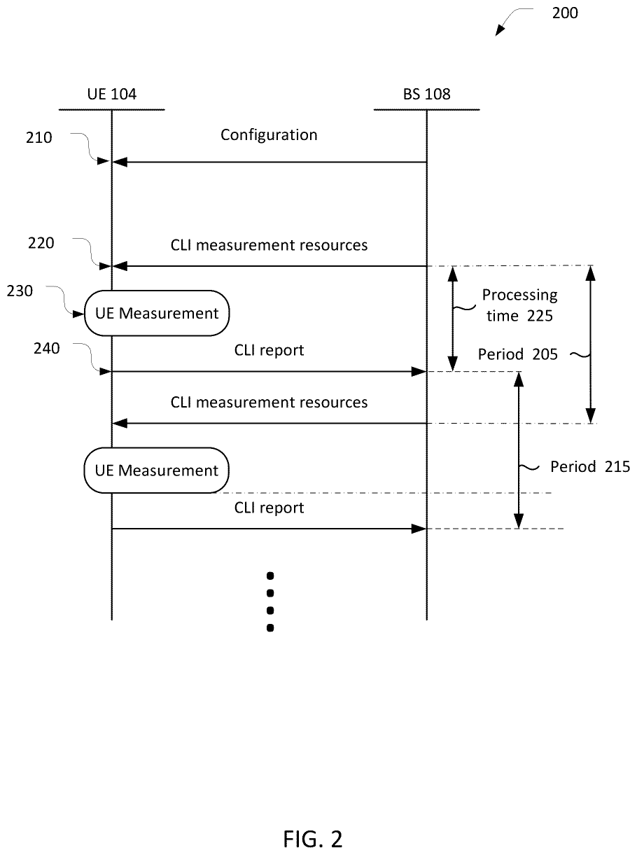

FIG. 2 is a signaling diagram 200 illustrating aspects of periodic channel measurement and reporting in accordance with some embodiments. The signaling diagram 200 may include operations performed by, and signaling messages transmitted between, the UE 104 and the base station 108. Operations described with respect to the base station 108 may be performed by one or more components of the RAN, including, for example, a transmission and reception point (TRP), a non-terrestrial network (NTN) device, etc. The signaling diagram 200 represents an embodiment in which periodic configuration is used for CLI measurement and reporting.

The base station 108 may allocate periodic measurement resources that the UE 104 may use to perform channel measurements, such as CLI measurement. The base station 108 may also associate periodic resources that UE 104 may use to periodically report its channel measurements, e.g., CLI measurement reports.

At 210, the base station 108 may send a message including a configuration associated with the measurement and reporting of CLI to the UE 104. The UE 104 may receive, process, and apply the configuration. The configuration may configure periodic CSI. The periodic CSI may include resources for periodic measurement and resources for periodic reporting.

The configuration may include information for CSI measurement. For example, the configuration may include fields associated with CSI reference signal (RS) resources or CSI reporting quantities, e.g., channel quality indicator (CQI), precoding matrix indicator (PMI), CSI-RS resource indicator (CRI), synchronization signal (SS) and physical broadcast channel (PBCH) (SSB) resource block indicator (SSBRI), layer indicator (LI), rank indicator (RI), L1 reference signal received power (RSRP), or L1 signal-to-interference-and-noise ratio (SINR).

The CSI measurement configuration may include a field specifying the periodicity of the CSI-RS resources, e.g., in terms of the number of slots between consecutive CSI-RS resources. The CSI-RS resources may include time-domain, e.g., in terms of the number of symbols or slots, frequency-domain resources, or spatial resources, e.g., allocated antennas or antenna ports.

The configuration may include information for CLI measurement. For example, the configuration may include fields associated with CLI measurement resources, CLI reporting quantity, e.g., CLI received signal strength indicator (RSSI), or CLI reporting resources.

The configuration may also include a field specifying the periodicity of the CLI measurement resources, e.g., in terms of the number of slots between consecutive CLI measurement resources. The CLI measurement resources may include time-domain, e.g., in terms of the number of symbols or slots, frequency-domain resources, and spatial resources, e.g., allocated antennas or antenna ports.

The CSI measurement configuration may identify the type of measurements. For example, the CSI measurement configuration may include one or more fields indicating whether the measurement includes CSI measurements, interference measurements (IM), or CLI measurements. The UE 104 may use CSI measurement and IM to obtain CSI reporting quantities, e.g., CQI, PMI, CRI, SSBRI, LI, RI, L1-RSRP, or L1-SINR. The UE 104 may use CLI measurement to obtain CLI report quantity, e.g., CLI-RSSI.

The configuration may include information for CSI reporting. For example, the configuration may include fields associated with resources for reporting CSI reporting quantities, e.g., CQI, PMI, CRI, SSBRI, LI, RI, L1-RSRP, or L1-SINR. The CSI reporting configuration may include a field specifying the periodicity of the CSI reports, e.g., in terms of the number of slots between consecutive reports. The CSI reporting configuration may include one or more fields to indicate the resources, e.g., time-domain, frequency-domain, or spatial resources, allocated for transmission of the CSI reports.

The configuration may include information for CLI reporting. For example, the configuration may include fields associated with resources for reporting CLI reporting quantity, e.g., CLI-RSSI. The CLI reporting configuration may include a field specifying the periodicity of the CLI reports, e.g., in terms of the number of slots between consecutive reports. The CLI reporting configuration may include one or more fields to indicate the resources, e.g., time-domain, frequency-domain, or spatial resources, allocated for transmission of the CSI reports.

At 220, the base station 108 may execute or use the resources allocated for CLI or CSI measurement. For example, the base station 108 may transmit the CSI-RS, e.g., configured CSI-RS sequence or signal, using the allocated time, frequency, or spatial resources. In another instance, the base station 108 may allocate the resources for CLI measurement.

The UE 104, at 220, may receive the signals on the CSI or CLI measurement resources. The UE may buffer or store the received signals, e.g., in digital or binary format. In some instances, the UE 104 may be configured with information about the received signal, e.g., the UE 104 may be configured with information associated with the received CSI-RS. In some instances, the UE 104 may not be configured with information about the received signals, e.g., the UE 104 may receive and buffer the values associated with the received signal amplitude, energy, or power, and without having information about the sequences or modulation symbols associated with the received signal.

At 230, the UE 104 may perform the measurement using the received signals at 220. In some instances, the UE 104 may immediately perform the measurement and compute the reporting quantity after receiving the signals on the CLI measurement resources.

In some instances, the UE 104 may measure the received signal strength. The UE 104 may quantize the measured received signal strength to obtain RSSI. The UE 104 may use a lookup table to quantize the measured received signal strength to obtain the RSSI. For example, the UE 104 may measure the RSSI on received signals on CLI resources to obtain CLI-RSSI.

The time between receiving the signal on CLI resources at 220 and the CLI reporting at 240 may be referred to as processing time 225. In some instances, the processing time may be defined as the duration from the end of the last CLI measurement resource, e.g., the last symbol of the slot in which the CLI measurement resource is scheduled, to the beginning of the CLI reporting, e.g., the first symbol of the slot in which the transmission of the CLI report is scheduled.

The UE 104 may report the minimum processing time needed to obtain a CLI report to the base station 108. For example, the UE 104 may send a UE capability report to the base station 108, including an indicator associated with the minimum processing time the UE 104 needs to compute the CLI report. In some instances, the 3GPP technical specifications, TSs, may define a minimum value for the processing time 225. The UE 104 may not expect to be scheduled by the base station 108 to report a measurement at a time sooner than the defined minimum value for the processing time 225 from receiving the measurement resources.

For periodic and semi-persistent CLI-RSSI reports, the minimum CLI-RSSI processing time may be S1 milliseconds (ms), S1=4 ms, when only one CLI-RSSI resource is configured for measurement, e.g., the total number of configured CLI-RSSI resources is one. The minimum CLI-RSSI processing time may be S2 ms, e.g., S2=5 ms when more than one CLI-RSSI resource is configured for measurement.

At 240, the UE 104 may generate a CLI report and send the report to the base station 108. The report may be transmitted using the configured CLI report resources.

Steps 220, 230, and 240 may repeat periodically. The time between two consecutive CLI measurement resources is the measurement period 205. The time between two consecutive CLI report generation or transmission is the reporting period 215. In some instances, the measurement period 205 and the reporting period 215 may have the same value. In other instances, the measurement period 205 and the reporting period 215 may have different values.

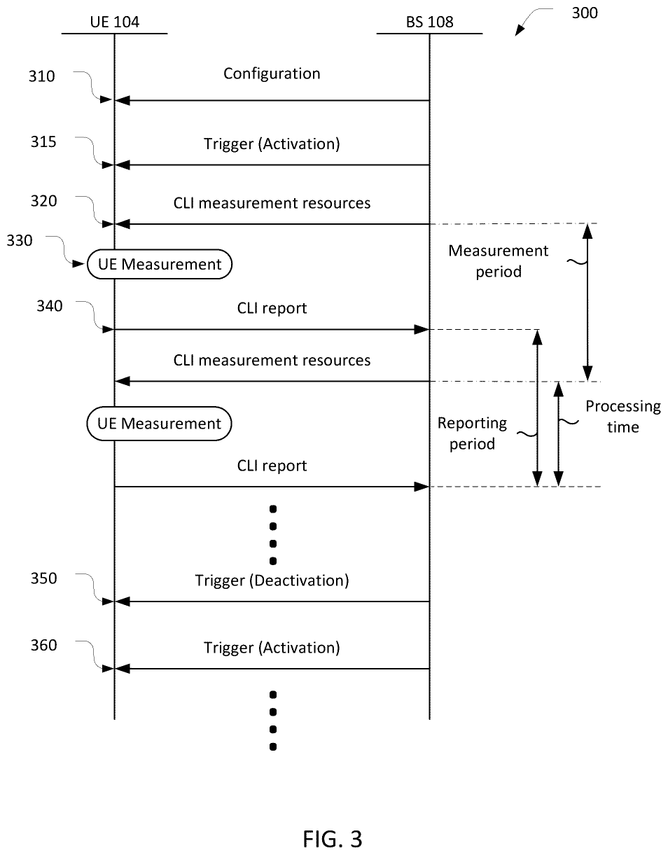

FIG. 3 is a signaling diagram 300 illustrating aspects of semi-persistent channel measurement and reporting in accordance with some embodiments. The signaling diagram 300 may include operations performed by, and signaling messages transmitted between, the UE 104 and the base station 108. Operations described with respect to the base station 108 may be performed by one or more components of the RAN, including, for example, a transmission and reception point (TRP), a non-terrestrial network (NTN) device, etc. The signaling diagram 300 represents an embodiment in which a semi-persistent configuration is used for CLI measurement and reporting. Except as otherwise described, operations and parameters of the signaling diagram 300 may be similar to like-named operations or parameters of the signaling diagram 200.

At 310, the base station 108 may send a message including a configuration associated with the measurement and reporting of CLI to the UE 104. The UE 104 may receive, process, and apply the configuration. The configuration may configure periodic CSI. The periodic CSI may include resources for periodic measurement and resources for periodic reporting. The configuration may include similar IE and fields as described above, with the difference that the measurement and reporting resources are semi-persistent. While the periodic resources, once configured, are scheduled and used, the semi-persistent resources need to be activated. Activated semi-persistent resources are similar to periodic resources. The base station 108 may deactivate semi-persistent resources.

At 315, the base station 108 may activate the semi-persistent CLI measurement or reporting resources. For example, the base station may use a medium access control (MAC) control element (CE) to activate the semi-persistent CLI measurement or reporting resources. The UE 104 may receive and process the activation indication sent by the base station 108 and activate the configuration and operations associated with the semi-persistent CLI resources.

Operations at step 320 are similar to those at step 220 in FIG. 2.

Operations at step 330 are similar to those at step 230 in FIG. 2.

Operations at step 340 are similar to those at step 240 in FIG. 2.

The UE 104 may continue receiving signals on the measurement resources and generate reports until it receives and processes a deactivation trigger at 350. At 350, the base station may generate and send a deactivation trigger to the UE 104. In response to the deactivation trigger, the UE 104 may suspend or stop receiving signals on the measurement resources associated with the deactivation trigger. The UE 104 may also stop generating the report associated with the measurement resources. For example, the base station 108 may deactivate measurement resources of one or more activated measurement resources. The base station may include the deactivation trigger in a MAC-CE. The deactivation trigger may also deactivate the generation report and the corresponding resources allocated for the transmission of the report.

The deactivated measurement or reporting resources may remain deactivated until the UE 104 receives a new activation trigger corresponding to the deactivated resources. At 360, the UE 104 may receive a new activation trigger associated with measurement or reporting resources. In response to the activation trigger, the UE 104 may start performing operations similar to those in steps 320, 330, or 340 using the activated resources.

The base station 108 may configure one or more measurement or reporting resources and may independently activate or deactivate them for semi-persistent measurement or reporting.

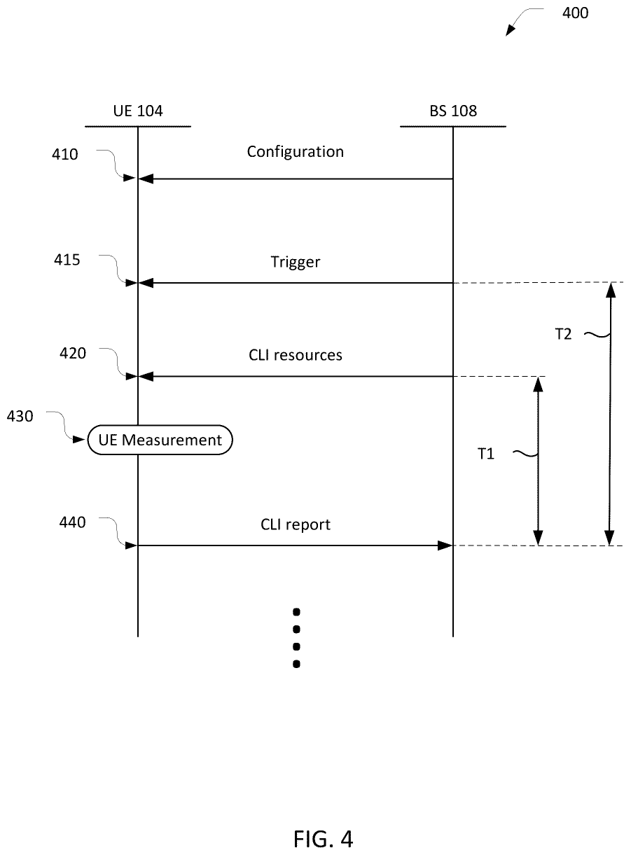

FIG. 4 is a signaling diagram 400 illustrating aspects of aperiodic channel measurement and reporting in accordance with some embodiments. The signaling diagram 400 may include operations performed by, and signaling messages transmitted between, the UE 104 and the base station 108. Operations described with respect to the base station 108 may be performed by one or more components of the RAN, including, for example, a transmission and reception point (TRP), a non-terrestrial network (NTN) device, etc. The signaling diagram 400 represents an embodiment in which aperiodic configuration is used for CLI measurement and reporting.

At 410, the base station 108 may send a configuration to the UE 104. The configuration may include fields similar to those in periodic or semi-persistent configurations. Aperiodic configuration may not include a field associated with the periodicity as the resources are used on-demand. The configuration message may allocate resources for aperiodic CLI measurement or reporting.

At 415, the base station 108 may send a trigger to initiate a CLI measurement or reporting session at the UE 104. In some instances, the base station 108 may send the trigger in response to a request from the UE 104. For example, the UE 104 may send a request to the base station 108 requesting the base station 108 to trigger an aperiodic measurement or reporting. The trigger may be included in a downlink control information (DCI). The DCI may include a field that directly or indirectly identifies the resources allocated for the measurement or reporting of CLI.

Operations at step 420 are similar to those at step 220 in FIG. 2.

Operations at step 430 are similar to those at step 230 in FIG. 2.

Operations at step 440 are similar to those at step 240 in FIG. 2.

The duration from receiving the CLI resources at 420 and transmitting or generating the CLI report at 440 is denoted by T1 in FIG. 4. The duration from receiving or processing the trigger at 415 and transmitting or generating the CLI report at 440 is denoted by T2 in FIG. 4. The 3GPP TSs may specify the minimum values for T1 and T2. The UE may not expect to receive or process any CLI resources within the duration of the specified minimum value for T1 from receiving or processing the trigger at 415. Similarly, the UE may not expect to be scheduled to report the CLI report within a duration of the specified minimum value for T2 from receiving or processing the trigger at 415.

For aperiodic CLI-RSSI reports, the UE may not be expected to support low latency aperiodic CLI-RSSI reports as defined in the 3GPP TS 38.214 v18.1.0 2024 Jan. 18. It may be assumed that the aperiodic CLI-RSSI reports meet the timeline requirements as defined in the 3GPP TS 38.214 (e.g., Z and Z′ in table 5.4-1 of TS 38.214). Alternatively, the UE may support low latency aperiodic CLI-RSSI report when CSI is triggered without a physical uplink shared channel (PUSCH) with a transport block or a hybrid automatic repeat request (HARQ) acknowledgment (ACK) or when the total CSI processing unit is zero.

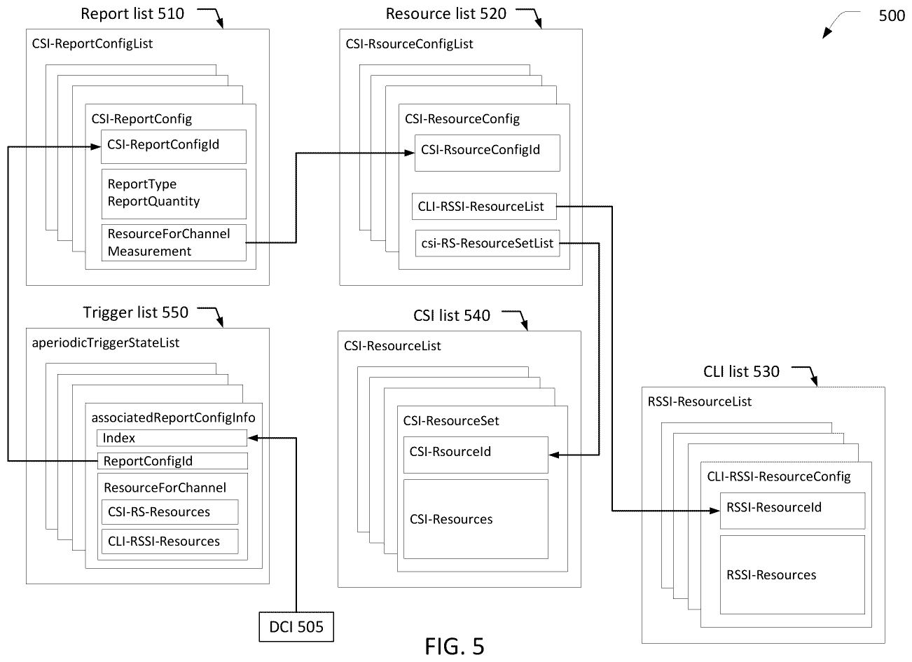

FIG. 5 illustrates resource and report configurations 500 in accordance with some embodiments. The resource and report configurations 500 is an example of information elements and data structures used to configure resources for measurement and reporting CLI or CSI.

In some instances, the periodic and semi-persistent configuration may include a report list 510, a resource list 520, a CLI list 530, and a CSI list 540. In other instances, the aperiodic configuration, in addition to the report list 510, the resource list 520, the CLI list 530, and the CSI list 540, may also include a trigger list 550.

In some embodiments, the base station may send a trigger to initiate aperiodic CLI measurement or reporting at the UE. For example, the base station may send a DCI 505 to trigger the CLI measurement or reporting. The DCI 505 may include an indication associated with a configuration in the trigger list 550.

The trigger list 550 may include one or more report configuration information IEs. Each report configuration information IE may include an index that identifies the report configuration information IE and an indication of a report configuration of report list 510. For example, the trigger list 550 may be the aperiodic trigger state list IE of the RRC configuration. The aperiodic trigger state list may include one or more associated report configuration information IE, e.g., associatedReportConfigInfo IE. The associated report configuration information IE may include an index field that identifies the associated report configuration information IE and a report configuration identifier (ID or Id), e.g., ReportConfigId, that identifies an IE in the report list 510.

The following configurations and information elements may be similar for periodic, semi-persistent, or aperiodic configurations. The differences between configurations or functionalities are explicitly explained.

The UE may be configured with report list 510. The report list 510 may include one or more report configurations. The report configuration may identify the measurement resources and the quantity to be measured. The report configuration may also identify the report resources. Each report configuration may include an ID and a field that identifies the type of the report, e.g., periodic, semi-persistent, or aperiodic. The report configuration may include a field that identifies one or more report quantities associated with the report, e.g., CQI, PMI, CRI, SSBRI, LI, RI, L1-RSRP, or CLI-RSSI. The report configuration may include an indication associated with the measurement resources in the resource list 520.

For example, the report list 510 may be the CSI report configuration list, e.g., CSI-ReportConfigList, in the RRC configuration. The CSI report configuration list may include one or more CSI report configuration IEs, e.g., CSI-ReportConfig IEs. The CSI report configuration may include a CSI report configuration ID, e.g., CSI-ReportConfigId, a report type, e.g., ReportType, a report quantity, e.g., ReportQuantity, and an indication associated with the measurement resources in the list 520, e.g., ResourceForChannelMeasurement.

The resource list 520 may include one or more resource configurations associated with resources allocated for channel measurement. Each resource configuration may include an Id, an indicator associated with CSI-RS resources in CSI list 540, or an indicator associated with CLI-RSSI resources in CLI list 530.

For example, the resource list 520 may be the CSI resource configuration list, e.g., CSI-ResourceConfigList, of RRC configurations. The CSI resource configuration list may include one or more CSI resource configuration IEs, e.g., CSI-ResourceConfig IEs. Each CSI resource configuration may include an Id, e.g., CSI-ResourceConfigId, one indicator that may be associated with a CLI RSSI resource list, e.g., CLI-RSSI-ResourceList, in CLI list 530 or an indicator associated with a CSI-RS resource set list, e.g., csi-RS-ResourceSetList, in CSI list 540.

The CLI list 530 may include one or more resources associated with resources, e.g., time-domain, frequency-domain, or spatial (antenna) resources allocated for CLI measurements. Each resource configuration in the CLI list 530 may include an ID that identifies the resource configuration and one or more fields associated with the resources, which may directly or indirectly identify the physical resources associated with the CLI measurement resources.

For example, the CLI list 530 may be an RSSI resource list, e.g., RSSI-ResourceList, of RRC configurations. The RSSI resource list may include one or more RSSI resource configuration CLI IEs, e.g., RSSI-ResourceConfigCLI IEs. Each RSSI resource configuration CLI IE may include an identifier field, e.g., RSSI-ResourceId, and one or more indications associated with the RSSI resources.

In another example, the CSI list 540 may be a CSI resource list, e.g., CSI-ResourceList, of RRC configurations. The CSI resource list may include one or more CSI resource set IEs, e.g., CSI-ResourceSet IEs. Each CSI resource set may include an identifier, e.g., CSI-ResourceId, or one or more indications associated with the CSI resources, e.g., CSI-Resources.

In some embodiments, the base station configures the UE to measure and report CLI-RSSI on the physical layer, e.g., L1. The CLI-RSSI report may be configured by the RRC CSI report configuration IE, e.g., CSI-ReportConfig. For example, the reference resources may be the RSSI measurement resources associated with RSSI-ResourceConfigCLI-r16. In some instances, the reference resources for CLI-RSSI measurement may be associated with non-zero-power (NZP) CSI-RS resources, e.g., RRC NZP-CSI-RS-Resource configuration.

In some embodiments, the CLI-RSSI measurement is configured as channel measurement resources (CMR) in the RRC CSI report configuration. For example, the CLI-RSSI measurement may be associated with the ResourceForChannelMeasurement field of the CSI-ReportConfig in RRC configurations. In some instances, SSB or CSI-RS may also be configured as CMR in a CSI-ReportConfig. For example, a

ResourceForChannleMeasurement field of the CSI-ReportConfig may include an indication associated with a CLI-RSSI measurement, a field associated with a SSB measurement, or a field associated with a CSI-RS measurements.

In some embodiments, the resource configuration IE of resource list 520 may configure one or more CLI RSSI measurement resources. For example, the CSI-ResourceConfig IE may include one or more CLI-RSSI-ResourceList fields, each associated with a CLI RSSI measurement resource, e.g., RSSI-ResourceConfigCLI.

In one example, the base station may trigger aperiodic CLI measurement. The base station may send the DCI 505 to trigger the aperiodic CLI measurement at the UE. The DCI 505 may include an indicator associated with a report configuration information IE in the trigger list 550. For example, the DCI 505 may include a field having a value. The UE may receive and process the DCI 505 to identify the value of the field and identify a report configuration information IE, e.g., RRC associatedReportConfigInfo IE, having an index associated with the field's value in the DCI 505. In some instances, the report configuration information may also include indicators associated with the CLI RSSI measurement resources or CSI-RS measurement resources, e.g., one or more of each of the CSI-RS-Resources or CLI-RSSI-Resources fields. In some instances, the report configuration information, e.g., RRC associatedReportConfigInfo, may include a report configuration identifier, e.g., ReportConfigId. The value of the report configuration identifier field may be associated with a report configuration of report list 510. For example, the value of the report configuration identifier may be associated with the report configuration ID of a report configuration in the report list 510.

Based on the report configuration ID, the UE may identify the report configuration IE in the report list 510. For example, the UE may identify the CSI-ReportConfig IE based on the ReportConfigId and the CSI-ReportConfigId field of the CSI-ReportConfig IE.

The following operations are similar for periodic, semi-persistent, or aperiodic CLI measurement or reporting.

The report configuration IE may include an indicator associated with the resources for channel measurement. For example, the CSI-ReportConfig IE may include the ResourceForChannelMeasurement field. The UE may identify the resource configuration of the resource list based on the indicator associated with the resources for the channel measurement field and the resource configuration identifier field of the resource configuration IEs in the resource list 520. For example, the UE may identify the CSI-ResourceConfig in the CSI-ResourceConfigList based on the ResourceForChannelMeasurement of the CSI-ReportConfig and the CSI-ResourceConfigId of the CSI-ResourceConfig IE.

The resource configuration may include one or more indications of each of the CLI-RSSI resource lists or CSI-RS resource set lists. For example, the CSI-ResourceConfig IE may include a CLI-RSSI-ResourceList that is associated with a RSSI-ResourceConfigCLI.

Based on the CLI-RSSI resource list field of the resource configuration IE and the RSSI resource ID field of the CLI-RSSI resource configuration IE, the UE may identify the configured CLI-RSSI resource configuration IE of the CLI list 530. The CLI-RSSI resource configuration may include one or more fields that directly or indirectly may determine the physical resources allocated for the configured CLI-RSSI measurement or reporting.

In one example, the CLI-RSSI resource configuration IE is an RSSI-ResourceConfigCLI IE. the UE may identify the configured RSSI-ResourceConfigCLI IE of the RRC RSSI-ResourceList configuration based on the CLI-RSSI-Resource List field of the configured CSI-ResourceConfig and the RSSI-ResourceId field of the RSSI-ResouceConfigCLI IEs of the RSSI-ResourceList. The one or more RSSI-Resources fields of the identified RSSI-ResourceConfigCLI IE may directly or indirectly identify the resources allocated for the CLI-RSSI measurements or reporting. In some instances, the RSSI-ResourceConfigCLI IE is an RSSI-ResourceConfigCLI-r16 IE.

In another example, the CLI-RSSI resource configuration IE may be an NZP-CSI-RS-ResourceSet IE or a zero-power (ZP)-CSI-RS-ResourceSet IE. The NZP-CSI-RS-ResourceSet IE may include one or more NZP-CSI-RS-ResourceId, each associated with an NZP-CSI-RS-Resource. Similarly, a ZP-CSI-RS-ResourceSet IE may include one or more ZP-CSI-RS-ResourceId, each associated with a ZP-CSI-RS-Resource.

In some instances, the resources for reporting CLI-RSSI may be scheduled or configured separately.

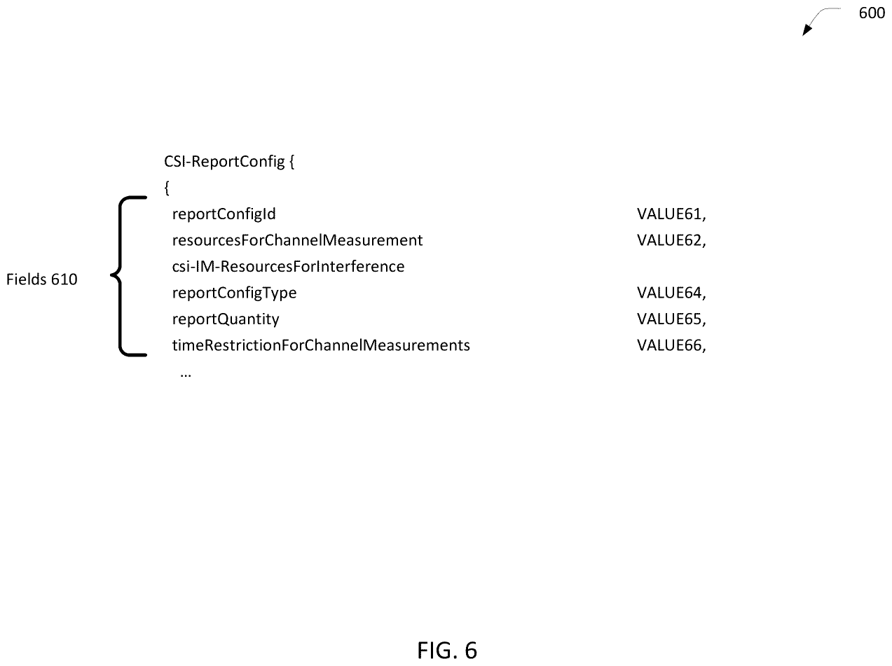

FIG. 6 illustrates a report configuration 600 in accordance with some embodiments. The report configuration 600 is an example of RRC CSI-ReportConfig IE having fields 610.

The CSI-ReportConfig IE may include reportConfigld, which may identify the CSI-ReportConfig IE having a value of VALUE61. A different CSI-ReportConfig IE may have a reportConfigId field with a value different from VALUE61. In one example, a DCI may trigger an aperiodic CLI measurement and report by identifying an associate ReportConfigInfo IE for the aperiodic CLI measurement. When the ReportConfigId field of an associatedReportConfigInfo IE has a value of VALUE61, the corresponding aperiodic CLI measurement is associated with this CSI-ReportConfig IE.

The CSI-ReportConfig IE may include a resourcesForChannleMeasurement field. This field may identify one or more CMR resources. For example, the value of the field, e.g., VALUE62, may be an array of values, where each value is an identifier of a CSI-ResourceConfig.

The CSI-ReportConfig IE may include a csi-IM-ResourcesForInterference field. The field may be associated with resources for measuring interferences other than CLI.

The CSI-ReportConfig IE may include a reportConfigType field. The value of the field, e.g., VALUE64, may determine the type of the report, e.g., periodic, semi-persistent, or aperiodic.

The CSI-ReportConfig IE may include a reportQuantity field. The value of the field, e.g., VALUE65, may determine the quantities that are included in the report. The quantities may be one or more of: CQI, PMI, CRI, SBRI, LI, RI, L1-RSRP, L1-SINR, or CLI-RSSI. The L1-RSRP and L1-SINR quantities may be referred to as beam management (BM) quantities. The CLI-RSSI quantity may be referred to as CLI quantity. The CQI, PMI, CRI, SSBRI, LI, or RI may be referred to as link adaptation (LA) quantities.

The CSI-ReportConfig IE may include a timeRestrictionForChannelMeasurements field. The value of this field, e.g., VALUE66, may be “configured” or “notConfigured,” indicating which CLI-RSSI resource may be used to obtain the CLI-RSSI report, similar to those specified in 3GPP TSs with regards to CSI-RS measurements.

In some embodiments, when CLI-RSSI resources are configured in CSI-RS configuration as CMR for L1-CLI-RSSI reporting, the UE may disregard or ignore the time Restriction ForChannelMeasurements field. The UE may assume that the value of the field, e.g., VALUE66, is always “configured.” When the field's value, e.g., VALUE66, is set to “configured,” the UE may measure and report the latest CLI-RSSI resource configuration no later than a CSI reference resource.

In some embodiments, if the timeRestrictionForChannelMeasurements field is set to “notConfigured,” the UE may measure and report based on multiple CLI-RSSI resource configurations no later than a CSI reference resource. The filtering or averaging of multiple measurements may be UE implementation. Alternatively, the base station may configure the filtering or averaging window.

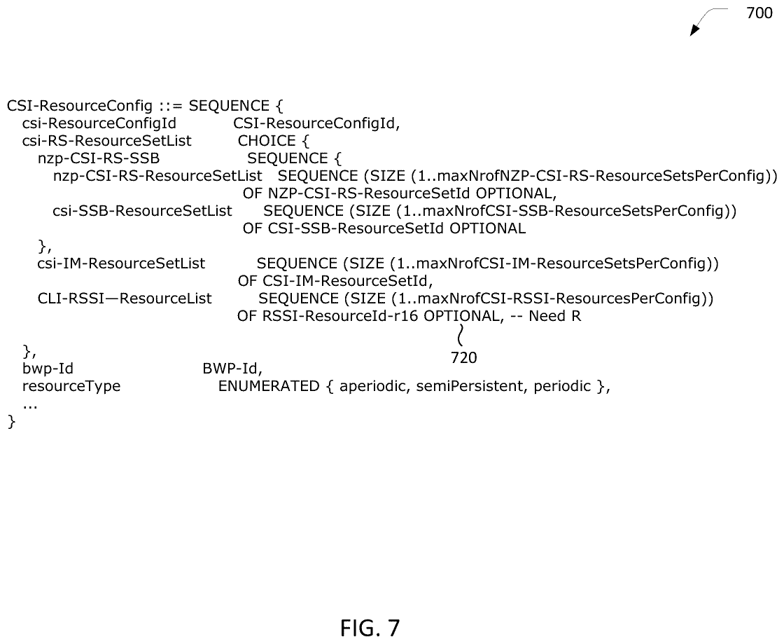

FIG. 7 illustrates a resource configuration 700 in accordance with some embodiments. The report configuration 700 is an example of RRC CSI-ResourceConfig IE.

The CSI-ResourceConfig IE may include a csi-ResourceConfigId field that identifies the IE. Other IEs may be associated with this IE by including the value of this field. For example, the resourcesForChannleMeasurement filed of the CSI-ReportConfig may include values equal to the value of the corresponding csi-ResourceConfigId.

The CSI-ResourceConfig IE may include a csi-RS-ResourceSetList field. The field may include one or more identifiers associated with NZP-CSI-RS sets or one or more identifiers associated with SSB resource sets.

The CSI-ResourceConfig IE may include a csi-IM-ResourceSetList field. The field may include one or more identifiers associated with CSI-IM resource sets that may be used for measuring interferences other than CLI.

The CSI-ResourceConfig IE may include a CLI-RSSI-ResourceList field. The field may include one or more identifiers associated with one or more RSSI-ResourceConfigCLI IEs.

In some embodiments, the UE may be configured with an initial BWP during the attachment or initial configuration. The UE may be configured with one or more BWPs. For example, the UE may be configured via RRC signaling with 1, 2, 4, or more BWPs. After the initial BWP the UE may receive RRC signaling including an indication of a first active BWP. After configuration with the first active BWP the UE may be configured, e.g., via DCI or RRC signaling, with a new BWP. The UE may also switch BWP to a configured default BWP based on the expiry of a BWP-inactivity timer.

The CSI-ResourceConfig IE may include a bwp-Id field, which is associated with the configured bandwidth part (BWP). In some embodiments, when the CSI-ResourceConfig 1E configures CLI-RSSI-ResourceList in CSI-ResourceConfigure, the UE may ignore or disregard the bwp-id field in CSI-ResourceConfig. The UE may measure the CLI-RSSI based on the active BWP of the configured serving cell in RSSI-ResourceConfigCLI IE.

The CSI-ResourceConfig IE may include a resourceType field. The field may indicate whether the resources are periodic, semi-persistent, or aperiodic resources.

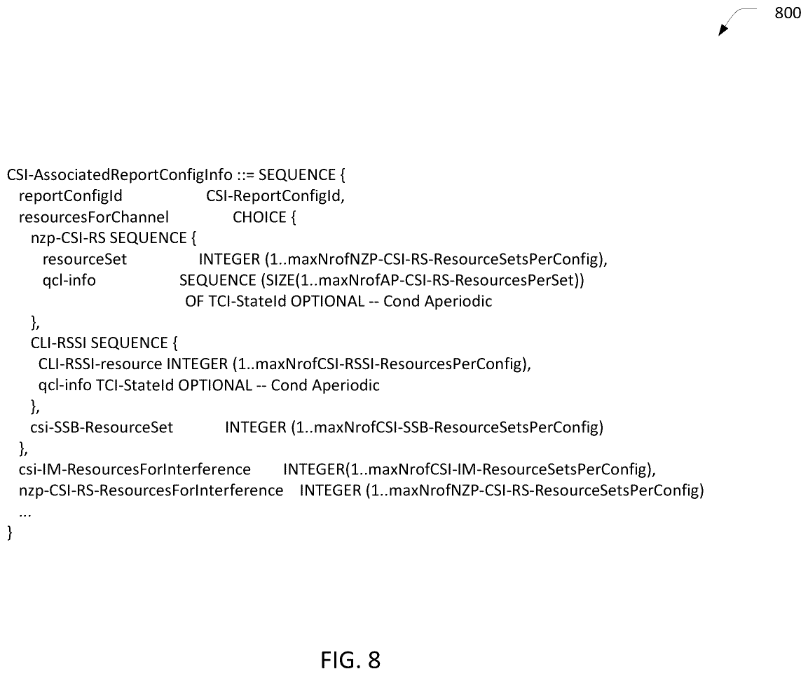

FIG. 8 illustrates a report configuration 800 in accordance with some embodiments. The report configuration 800 is an example of RRC CSI-AssociatedReportConfigInfo IE.

The CSI-AssociatedReportConfigInfo IE may include a reportConfigld field. The field may be used to identify the IE. For example, the base station may include the identifier of a configured CSI-AssociatedReportConfigInfo IE in a DCI to trigger an aperiodic CLI measurement and reporting.

The CSI-AssociatedReportConfigInfo IE may include a resourcesForChannel field. This field may configure one or more NZP-CSI-RS for aperiodic CSI measurements and associated quasi-colocation (QCL) information. This field may configure one or more CLI-RSSI resources for aperiodic CLI measurements and associated QCL information. This field may configure one or more SSB resources for aperiodic measurement.

The CSI-AssociatedReportConfigInfo IE may include a CSI-IM-ResourcesForInterference field. This field may configure one or more resources for interference measurement other than CLI.

The CSI-AssociatedReportConfigInfo IE may include a nzp-CSI-RS-ResourcesForInterference field. This field may configure one or more NZP-CSI-RS resources for interference (other than CLI) measurement.

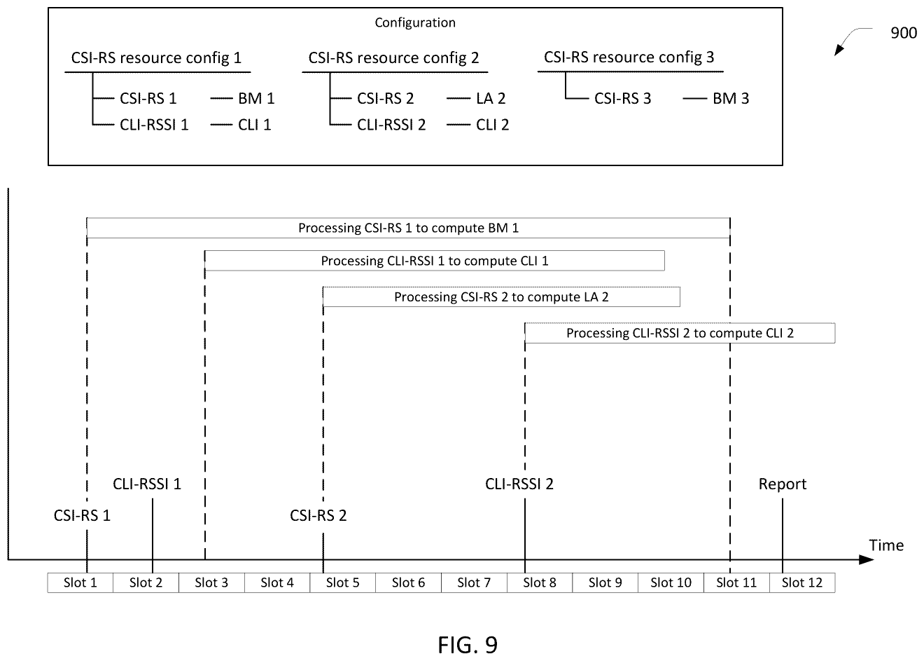

FIG. 9 illustrates processing and reporting 900 in accordance with some embodiments. The processing and reporting 900 is an example of measurement, report generation, prioritization, and reporting procedure. In this example, three CSI-RS resources are configured, e.g., CSI-RS Resource Configs 1-3.

The CSI-RS resource config 1 includes configuration for CSI-RS, e.g., CLI-RS 1, to measure one or more beam management quantities and generate a beam management report, e.g., BM 1. The CSI-RS resource config 1 includes configuration for CLI-RSSI, e.g., CLI-RSSI 1, to measure CLI quantity and generate a CLI report, e.g., CLI 1.

The CSI-RS resource config 2 includes configuration for CSI-RS, e.g., CSI-RS 2, to measure one or more link adaptation quantities and generate a link adaptation report, e.g., LA 2. The CSI-RS resource config 2 includes configuration for CLI-RSSI, e.g., CLI-RSSI 2, to measure a CLI quantity and generate a CLI report, e.g., CLI 2.

Finally, the CSI-RS resource config 3 includes configuration for CSI-RS, e.g., CSI-RS 3, to measure one or more beam management quantities and generate a beam management report, e.g., BM 3. The reports, e.g., BM 1, CLI 1, LA 2, CLI 2, or BM 3 may include the quantities associated with each report.

At slot 1, the UE may receive and process the signals on measurement resources associated with the CSI-RS 1. The UE may immediately start processing CSI-RS 1 to compute BM 1. The processing for computing BM 1 may end at some time during slot 11.

At slot 2, the UE may receive and process the signals on measurement resources associated with the CLI-RSSI 1. The UE may start processing the CLI-RSSI-measured signals to obtain CLI 1 after a delay, e.g., at slot 3. The computation of CLI 1 may end at some time during slot 10.

At slot 5, the UE may receive and process the signals on measurement resources associated with the CSI-RS 2. The UE may immediately start processing CSI-RS 2 to compute LA 2. The processing for computing LA 2 may end sometime during slot 10.

At slot 8, the UE may receive and process the signals on measurement resources associated with the CLI-RSSI 2. The UE may immediately start processing the CLI-RSSI 2 to compute the CLI 2. The processing of CLI 2 may end at the end of slot 12.

At slot 12, the UE may generate and send the final report.

In some embodiments, the UE may transmit all the computed reports in the final report. For example, the final report may include the BM 1, CLI 1, and LA 2 reports.

In some embodiments, the UE may generate the final report that includes only one of the computed reports. For example, the UE may select one of BM 1, CLI 1, or LA 2 reports to generate the final report. The UE may select the report to be included in the final report based on the priority associated with beam management, link adaptation, or CLI reports.

In some instances, CLI-RSSI reports may have the same priority as link adaptation reports. In some instances, CLI-RSSI reports may have the same priority as beam management reports. In other instances, the CLI-RSSI reports may have a lower priority than link adaptation reports. In some other instances, the CLI-RSSI reports may have a priority lower than the beam management reports but higher than the link adaptation reports. In other instances, the CLI-RSSI reports may have a higher priority than the beam management reports.

In some embodiments, the UE may have a limitation on the maximum number of CSI-RS and SSB that it can process concurrently during one slot. For example, at slot 2, the UE is processing one CSI-RS, and in slots 5-10, the UE is processing 2 CSI-RSs.

The UE may have a limitation on the maximum number of CLI-RSSI that it can process concurrently during one slot. For example, in slots 3-7, the UE is processing one CLI-RSSI, and in slots 8-10, the UE is processing 2 CLI-RSSIs.

The UE may have a limitation on the maximum total number of CSI-RS and CLI-RSSI that it can process concurrently. For example, in slots 1-2, the UE is processing a total of 1 CSI-RS and CLI-RSSI; in slots 3 and 4, the UE is processing a total of 2 CSI-RS and CLI-RSSI; in slots 5-7, the UE is processing a total of 3 CSI-RS and CLI-RSSI; and in slots 8-10, the UE is processing a total of 4 CSI-RS and CLI-RSSI.

In some instances, the UE may report its CSI processing unit (CPU) capability to the base station. The CPU may be associated with the maximum number of CSIs the UE can process concurrently. The UE may report a single CPU value indicating a maximum number of CSI-RS, SSB, or CLI-RSSI that it can process concurrently. Alternatively, the UE may report one value for the maximum number of CSI-RS and SSB, which can be processed concurrently, and another value for the maximum number of CLI-RSSI, which can be processed concurrently.

The UE or the base station may count the number of CPUs based on the configured CSI-RS and CLI-RSSI. To compute the CPU, the UE or the base station may count the number of CLI-RSSI resources that are configured. For example, one CSI report may configure 2 RSSI-ResourceConfigCLI, the UE or the base station may count each configured CLI-RSSI resource as one CPU count, or the UE or the base station may count all configured CLI-RSSI resources as one CPU count. Alternatively, the UE or the base station may count each configured CSI report as one CPU count. Additionally, or alternatively, the UE may report, e.g., via UE capability report, the number of occupied CPUs for each CSI report.

The UE may have a limitation on the number of active RSs it can process. The UE or the base station may consider the configured (and activated for the semi-persistent CLI-RSSI) CLI-RSSI in counting the number of active RSs the same way that the UE or base station may consider an active CSI-RS. Alternatively, the UE may separately report, e.g., via UE capability, the number of active RSs for CLI-RSSI reports.

In some instances, the UE or the base station may count each configured CLI-RSSI resource, e.g., RSSI-ResourceConfigCLI, as one active RS in the slot it is scheduled, e.g., transmitted by the base station or received by the UE. Alternatively, the UE or the base station may count each configured CLI-RSSI resource as one active RS, even in the slot it is not scheduled.

For aperiodic CLI-RSSI, the CLI-RSSI resource may be counted as an active RS starting from the physical downlink control channel (PDCCH) containing the DCI that triggers the aperiodic CLI-RSSI and ending at the end of the scheduled physical uplink shared channel (PUSCH) containing the report. The starting time may be the first or the last symbol of the PDCCH containing the DCI that triggers the aperiodic CLI-RSSI. The ending may be the first or the last symbol of the PUSCH containing the report.

For semi-persistent CLI-RSSI, the CLI-RSSI resource may be counted as an active RS starting from the time that the activation command is applied and ending when the deactivation command is applied. The starting time may be the first, the last, or the exact symbol at which the activation command is applied. The ending time may be the first, the last, or the exact symbol at which the deactivation command is applied.

For periodic CLI-RSSI, the CLI-RSSI resource may be counted as an active RS starting when the periodic CSI-RS containing the CLI-RSSI configuration is configured by higher-layer signaling and ending when the periodic CSI-RS configuration is released. The starting time may be the first or the last symbol at which the higher-layer signaling configuring the CLI-RSSI is received. The ending time may be the first or the last symbol at which the CLI-RSSI configuration is released by higher-layer signaling.

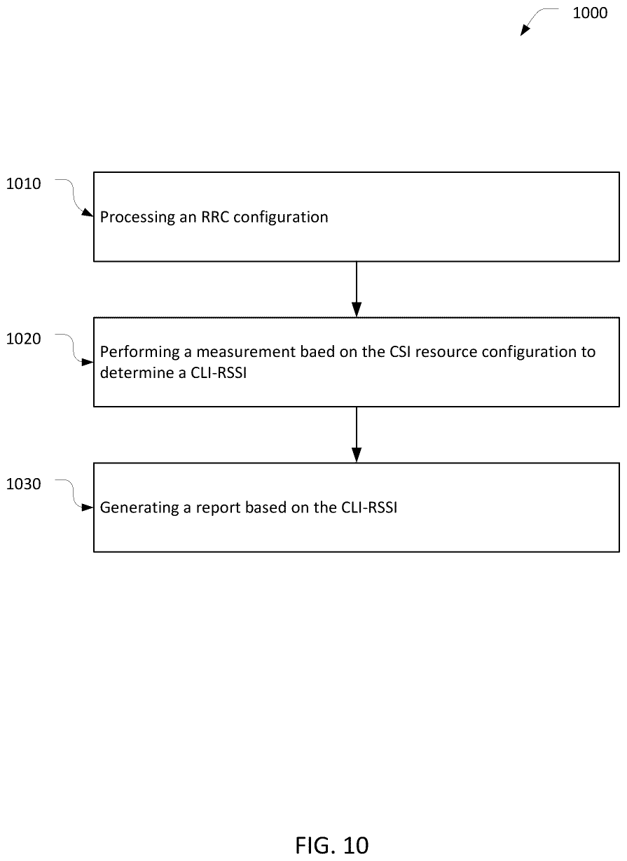

FIG. 10 illustrates an operation flow/algorithmic structure 1000 in accordance with some embodiments. The operation flow/algorithmic structure 1000 may be performed or implemented by a UE such as, for example, the UE 104 or UE 1300; or components thereof, for example, baseband processor circuitry 1304A.

The operation flow/algorithmic structure 1000 may include, at 1010, processing an RRC configuration. The RRC configuration may include a CLI-RSSI resource configuration and a CSI resource configuration. The CSI resource configuration may include a CSI-RS set list, including a CSI-RS resource set identifier, and a CLI-RSSI resource set list associated with the CLI-RSSI resource configuration.

The CSI resource configuration may include a bandwidth part identifier associated with a bandwidth part. For performing CLI-RSSI measurement, the UE may disregard the bandwidth part identifier and associated bandwidth part.

For aperiodic CLI measurement or reporting, the RRC configuration may include CSI associated report configuration information. The CSI associated report configuration information may include an indication associated with an NZP-CSI-RS configuration and an indication associated with a CLI-RSSI configuration.

The CSI Report Configuration may include a report quantity field. The report quantity field may indicate the measurement or reporting of one or more of the following quantities: CQI, PMI, CRI, SBRI, LI, RI, L1-RSRP, L1-SINR, or CLI-RSSI. In some instances, the report may only include a CLI-RSSI. In other instances, the report may include a CLI-RSSI quantity and one or more quantities from CQI, PMI, CRI, SBRI, LI, RI, L1-RSRP, or L1-SINR.

The operation flow/algorithmic structure 1000 may include, at 1020, performing a measurement based on the CSI resource configuration to determine a CLI-RSSI.

The operation flow/algorithmic structure 1000 may include, at 1030, generating a report based on the CLI-RSSI.

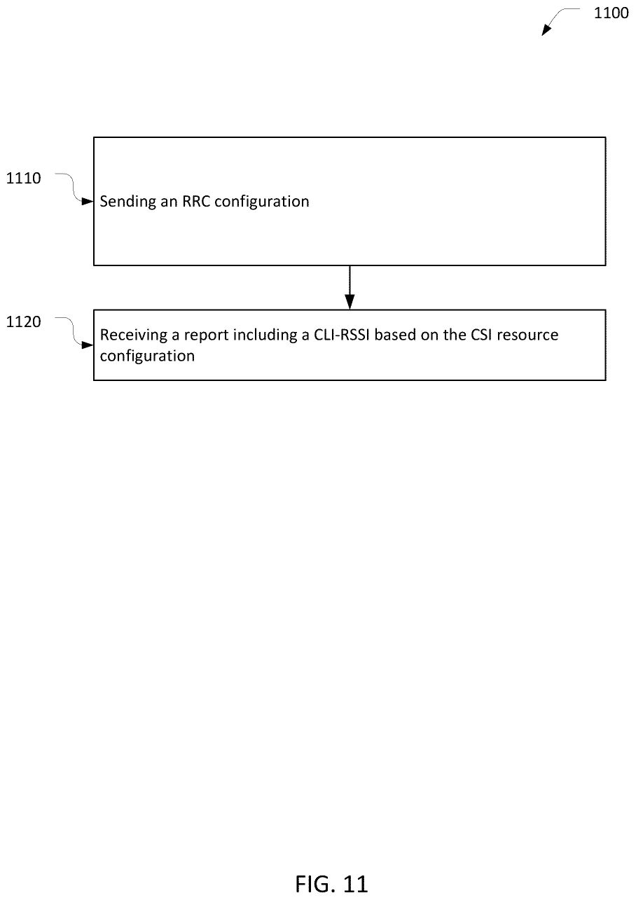

FIG. 11 illustrates an operational flow/algorithmic structure 1100 in accordance with some embodiments. The operation flow/algorithmic structure 1100 may be performed or implemented by a base station such as, for example, the base station 108 or the base station 1400; or components thereof, for example, baseband processor circuitry 1404A.

The operation flow/algorithmic structure 1100 may include, at 1110, sending an RRC configuration. The RRC configuration may include a CLI-RSSI resource configuration and a CSI resource configuration. The CSI resource configuration may include a CSI-RS set list, including a CSI-RS resource set identifier, and a CLI-RSSI resource set list associated with the CLI-RSSI resource configuration.

For aperiodic CLI measurement or reporting, the RRC configuration may include CSI associated report configuration information. The CSI associated report configuration information may include an indication associated with an NZP-CSI-RS configuration and an indication associated with a CLI-RSSI configuration.

The CSI Report Configuration may include a report quantity field. The report quantity field may indicate the measurement or reporting of one or more of the following quantities: CQI, PMI, CRI, SBRI, LI, RI, L1-RSRP, L1-SINR, or CLI-RSSI. In some instances, the report may only include a CLI-RSSI. In other instances, the report may include a CLI-RSSI quantity and one or more quantities from CQI, PMI, CRI, SBRI, LI, RI, L1-RSRP, or L1-SINR.

The operation flow/algorithmic structure 1100 may include, at 1120, receiving a report including a CLI-RSSI based on the CSI resource configuration.

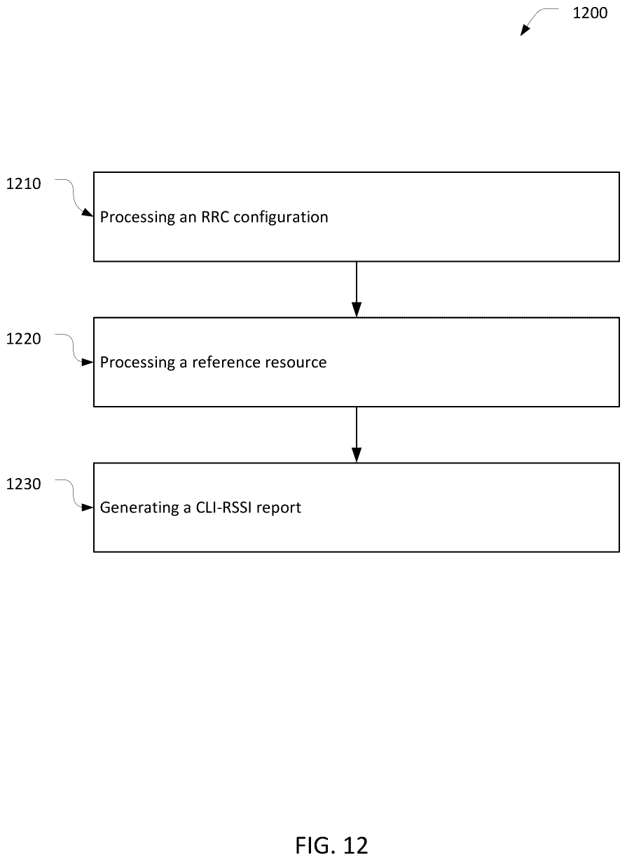

FIG. 12 illustrates an operational flow/algorithmic structure 1200 in accordance with some embodiments. The operation flow/algorithmic structure 1200 may be performed or implemented by a UE such as, for example, the UE 104 or UE 1300; or components thereof, for example, baseband processor circuitry 1304A.

The operation flow/algorithmic structure 1200 may include, at 1210, processing an RRC configuration. The RRC configuration may include a CSI-ReportConfig IE, a CSI-ResourceConfig IE, or a CSI-AssociatedReportConfigInfor IE. The RRC configuration may include RSSI-ResourceConfiguCLI-r16 IE.

The UE may perform an L1 CLI-RSSI measurement and obtain a CLI-RSSI report based on the L1 CLI-RSSI measurement. The CLI-RSSI report may be configured by the CSI-ReportConfig IE.

To perform the L1 CLI-RSSI measurement, UE may use one or more reference resources. For a reference resource, a RSSI-ResourceConfiguCLI-r16 IE may be used. The RRC configuration may configure the RSSI-ResourceConfiguCLI-r16 IE to be used for L1 CLI-RSSI measurement. In some instances, NZP-CSI-RS-Resource IE may be configured by the RRC configuration as a reference resource for L1 CLI-RSSI measurement.

In some instances, only channel measurement resources (CMRs) can be configured in CSI-ReportConfig IE for L1 CLI-RSSI measurement. The resourcesForChannleMeasurement in CSI-ReportConfig IE may configure the reference signals for L1 CLI-RSSI measurement. For example, the resourceForChannelMeasurement may configure the RSSI-ResourceConfiguCLI-r16 for L1 CLI-RSSI measurement.

In CSI-ResourceConfig one or more RSSI-ResourceConfiguCLI-r16 may be configured. When CSI-ReportConfig configures RSSI-ResourceConfiguCLI-r16 as CMR, the UE may measure L1 CLI-RSSI based on the active BWP of the configured serving cell in RSSI-ResourceConfiguCLI-r16. In some instances, only one RSSI-ResourceConfiguCLI-r16 may be configured as CMR for L1 CLI-RSSI reporting in CSI-ResourceConfig IE.

The CSI-ResourceConfig IE may include a timeRestrictionForChannelMeasurement field. In some instances, the UE may ignore this field. UE may always assume that the field's value is “configured” regardless of the field's actual value. The UE may measure the report L1 CLI-RSSI based on the latest RSSI-ResourceConfiguCLI-r16 no later than the CSI reference resource.

Alternatively, the UE may consider the value of time REstrictionForChannleMeasurements field. When this field is set to “notConfigured” the UE may measure and report based on multiple RSSI-ResourceConfiguCLI-r16 no later than the CSI reference resource. In one instance, the filtering or averaging process is based on UE implementation. In other instances, the filtering or averaging window may be configured by the base station or may be defined in the 3GPP specifications.

The operation flow/algorithmic structure 1200 may include, at 1220, processing a reference resource. The UE may process the reference resource, e.g., RSSI-ResourceConfiguCLI-r16, based on the RRC configuration. The UE may process the reference resource to perform an L1 CLI-RSSI measurement.

The operation flow/algorithmic structure 1200 may include, at 1230, generating a CLI-RSSI report. The UE may generate the CLI-RSSI report based on the L1 CLI-RSSI measurement. The reportQuantity field of the CSI-ReportConfig may be set to “CLI-RSSI” to indicate that the CSI report includes the CLI-RSSI report.

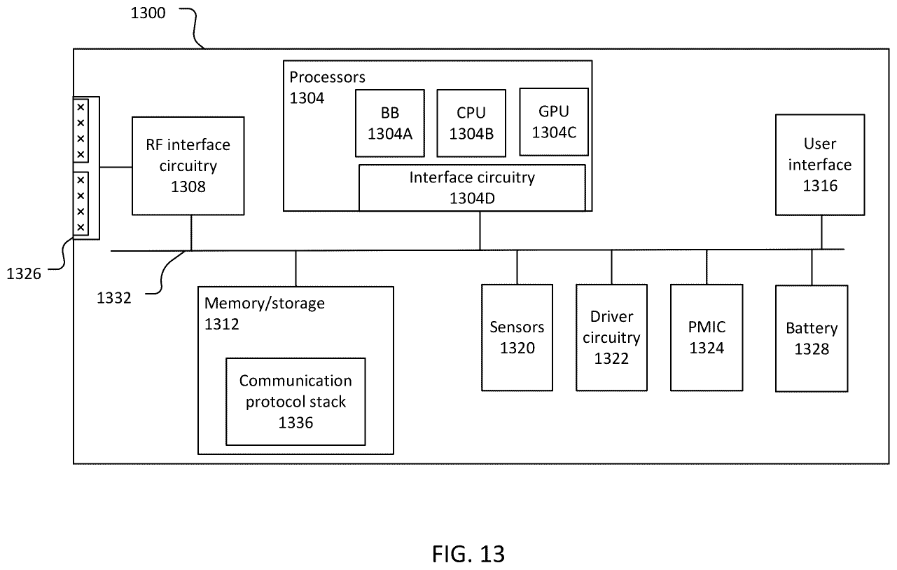

FIG. 13 illustrates a UE 1300 in accordance with some embodiments. The UE 1300 may be similar to and substantially interchangeable with the UE 104.

The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1300 may include processors 1304, RF interface circuitry 1308, memory/storage 1312, user interface 1316, sensors 1320, driver circuitry 1322, power management integrated circuit (PMIC) 1324, antenna 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1332, which may represent any type of interface, input/output, bus (local, system, or expansion), transmission line, trace, or optical connection that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform delay-adaptive operations as described herein. The processors 1304 may also include interface circuitry 1304D to communicatively couple the processor circuitry with one or more other components of the UE 1300.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack 1336 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform various delay-adaptive operations described herein.

The memory/storage 1312 includes any type of volatile or non-volatile memory that may be distributed throughout the UE 1300. In some embodiments, some of the memory/storage 1312 may be located on the processors 1304 themselves (for example, memory/storage 1312 may be part of a chipset that corresponds to the baseband processor circuitry 1304A), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, or phased array antennas. The antenna 1326 may have one or more panels designed for specific frequency bands including bands in FR1 or FR2.

The user interface 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1300.

The sensors 1320 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensors 1320 and control and allow access to sensors 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

A battery 1328 may power the UE 1300, although in some examples the UE 1300 may be mounted deployed in a fixed location and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

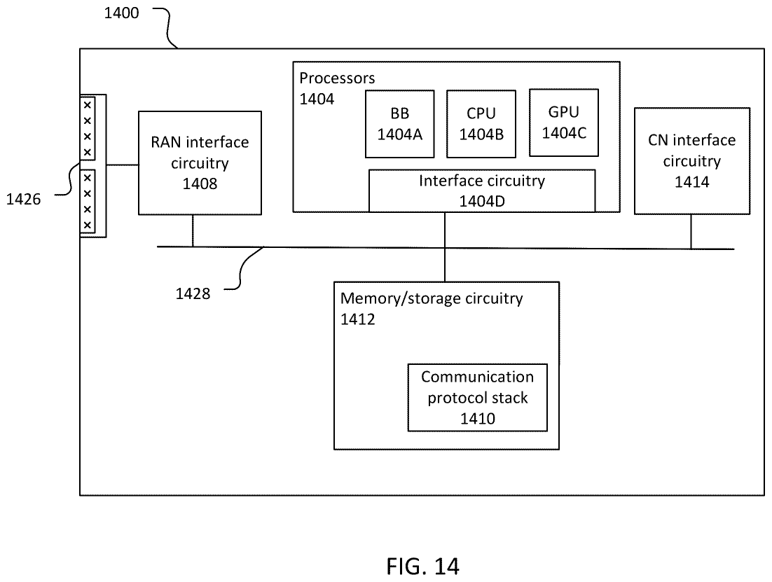

FIG. 14 illustrates a network device 1400 in accordance with some embodiments. The network device 1400 may be similar to and substantially interchangeable with base station 108.

The network device 1400 may include processors 1404, RF interface circuitry 1408 (if implemented as a base station), core network (CN) interface circuitry 1414, memory/storage circuitry 1412, and antenna structure 1426.

The components of the network device 1400 may be coupled with various other components over one or more interconnects 1428.

The processors 1404, RF interface circuitry 1408, memory/storage circuitry 1412 (including communication protocol stack 1410), antenna structure 1426, and interconnects 1428 may be similar to like-named elements shown and described with respect to FIG. 13.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage circuitry 1412 to cause the UE 1400 to perform delay-adaptive operations as described herein. The processors 1404 may also include interface circuitry 1404D to communicatively couple the processor circuitry with one or more other components of the network device 1400.

The CN interface circuitry 1414 may provide connectivity to a core network, for example, a 5th Generation Core network (5GC) using a 5GC-compatible network interface protocol such as carrier Ethernet protocols, or some other suitable protocol. Network connectivity may be provided to/from the network device 1400 via a fiber optic or wireless backhaul. The CN interface circuitry 1414 may include one or more dedicated processors or FPGAs to communicate using one or more of the aforementioned protocols. In some implementations, the CN interface circuitry 1414 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method including: processing a radio resource control (RRC) configuration received from a base station, the RRC configuration including: a cross link interference (CLI)-received signal strength indicator (RSSI) resource configuration; and a channel state information (CSI) resource configuration having: a CSI reference signal (RS) resource set list including a CSI-RS resource set identifier; and a CLI-RSSI resource list associated with the CLI-RSSI resource configuration; performing a measurement based on the CSI resource configuration to determine a CLI-RSSI; and generating a report, to be transmitted to the base station, based on the CLI-RSSI.

Example 2 includes the method of example 1 or some other examples herein, wherein the CLI-RSSI resource configuration is an RSSI-ResourceConfigCLI configuration or a non-zero-power-CSI-RS-ResourceSet.

Example 3 includes the method of examples 1 or 2 or some other examples herein, wherein the CSI resource configuration includes a bandwidth part identifier associated with a bandwidth part, and the method further including: processing an indication associated with an active bandwidth part; and wherein said performing the measurement further comprises: performing the measurement based on the active bandwidth part.

Example 4 includes the method of any of examples 1-3 or some other examples herein, wherein the RRC configuration includes a CSI associated report configuration information having: a first indicator associated with a non-zero-power (NZP) CSI-RS configuration; and a second indicator associated with a CLI-RSSI configuration including an indication of CLI-RSSI resources or quasi-colocation information.

Example 5 includes the method of any of examples 1-4 or some other examples herein, wherein the RRC configuration includes a time restriction for channel measurement information having a configured value, and the method further including: assigning a value of “CONFIGURED” to the configured value; and wherein said performing the measurement includes: performing the measurement based on the assigned value.

Example 6 includes the method of any of examples 1-5 or some other examples herein, wherein the RRC configuration includes a time restriction for channel measurement information having a configured value, and the method further includes: determining that the configured value is “NOTCONFIGURED”; processing an averaging window configuration received from the base station; determining an averaging window associated with the measurement based on the averaging window configuration; and wherein said performing the measurement further includes: performing the measurement based on the averaging window configuration.

Example 7 includes the method of any of examples 1-6 or some other examples herein, wherein the RRC configuration includes a CSI report configuration having a report quantity field indicating that the CLI-RSSI is to be measured and reported.

Example 8 includes the method of any of examples 1-7 or some other examples herein, wherein the report quantity field indicates that only CLI-RSSI is to be measured and reported.

Example 9 includes the method of any of examples 1-8 or some other examples herein, wherein a priority of the report is equal to a priority of a beam management (BM) CSI report, or a priority of the report is equal to a priority of a link adaptation (LA) CSI report.

Example 10 includes the method of any of examples 1-9 or some other examples herein, wherein: the report is a periodic report or a semi-persistent report; and a total CLI-RSSI resource configuration only includes the CLI-RSSI resource configuration and a minimum CLI-RSSI processing time is 4 milliseconds (ms), or the CLI-RSSI resource configuration is a first CLI-RSSI resource configuration, a total CLI-RSSI resource configuration includes the first CLI-RSSI resource configuration and a second CLI-RSSI resource configuration, and a minimum CLI-RSSI processing time is 5 (ms).

Example 11 includes the method of any of examples 1-10 or some other examples herein, wherein the report is an aperiodic report, and the method further includes: processing a trigger received from the base station to initiate the measurement.

Example 12 includes the method of any of examples 1-11 or some other examples herein, wherein a first period, indicating a first time between a reception of the trigger and the measurement, is smaller than a first threshold or a second period, indicating a second time between a reception of the trigger and a transmission of the report, is smaller than a second threshold.

Example 13 includes the method of any of examples 1-12 or some other examples herein, further including: generating a capability report, to be sent to the base station, including an indication of a number of processing units associated with a number of CLI-RSSIs that the UE is capable of generating concurrently.

Example 14 includes the method of any of examples 1-13 or some other examples herein, further including: determining a number of CSI processing unit, based on a number of configured CLI-RSSI resources.

Example 15 includes a method including: sending a radio resource control (RRC) configuration, to a user equipment (UE), including: a cross link interference (CLI)-received signal strength indicator (RSSI) resource configuration; and a channel state information (CSI) resource configuration having: a CSI reference signal (RS) set list including a CSI-RS resource set identifier; and a CLI-RSSI resource list associated with the CLI-RSSI resource configuration; and receiving a report including a CLI-RSSI, from the UE, based on the RRC configuration.

Example 16 includes the method of example 15 or some other examples herein, wherein the CLI-RSSI resource configuration is an RSSI-ResourceConfigCLI configuration or a non-zero-power-CSI-RS-ResourceSet.

Example 17 includes the method of examples 15 or 16 or some other examples herein, wherein the RRC configuration includes a CSI associated report configuration information having: a first indication associated with a non-zero-power (NZP) CSI reference signal (RS) configuration; and a second indication associated with the CLI-RSSI resource configuration including an indication of CLI-RSSI resources or quasi-colocation information.

Example 18 includes the method of any of examples 15-17 or some other examples herein, wherein the RRC configuration includes a CSI report configuration having a report quantity field indicating that the CLI-RSSI is to be measured and reported.

Example 19 includes the method of any of examples 15-18 or some other examples herein, wherein the report quantity field indicates that only CLI-RSSI is to be measured and reported.

Example 20 includes the method of any of examples 15-19 or some other examples herein, further including: receiving a capability report, from the UE, including an indication of a number of processing units associated with a number of CLI-RSSIs that the UE is capable of determining concurrently.

Example 21 includes a method including: processing a radio resource control (RRC) configuration including a channel state information (CSI)-Report configuration associated with a layer 1 (L1) cross link interference (CLI)-received signal strength indicator (RSSI) measurement and a CLI-RSSI report; processing a reference resource based on the RRC configuration for the L1 CLI-RSSI measurement; and generating the CLI-RSSI report based on the L1 CLI-RSSI measurement.

Example 22 includes the method of example 21 or some other examples herein, wherein the reference resource is configured as a channel measurement resource (CMR) based on a resourceForChannelMeasurement field in the CSI-Report configuration.

Example 23 includes the method of examples 21 or 22 or some other examples herein, wherein the reference resource is associated with: an RSSI-Resource Configuration CLI-r16 information element (IE); or a non-zero-power (NZP)-CSI-reference signal (RS)-Resource IE.

Example 24 includes the method of any of examples 21-23 or some other examples herein, wherein the reference resource is associated with the RSSI-Resource Configuration CLI-r16 IE, and the RRC configuration includes a CSI-Resource configuration associated with configuration of the RSSI-Resource Configuration CLI-r16 IE.

Example 25 includes the method of any of examples 21-24 or some other examples herein, wherein the RSSI-Resource Configuration CLI-r16 IE includes an indication of a serving cell, and the method further includes: measuring an RSSI based on an active bandwidth part associated with the serving cell.

Example 26 includes the method of any of examples 21-25 or some other examples herein, wherein the reference resource is associated with the RSSI-Resource Configuration CLI-r16 IE, the RRC configuration includes a CSI-AssociatedReportConfigInfor IE that includes: an index associated with the RSSI-Resource Configuration CLI-r16 IE; or a quasi-colocation (QCL) information associated with a reception of the reference resources.

Example 27 includes the method of any of examples 21-26 or some other examples herein, wherein the CSI-Report configuration includes a reportQuantity field associated with a CSI report, the reportQuantity having a value of “CLI-RSSI” to indicate the CSI report includes the CLI-RSSI report.

Another example may include an apparatus comprising means to perform one or more elements of a method described in or related to any of examples 1-27, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-27, or any other method or process described herein.

Another example may include an apparatus comprising logic, modules, or circuitry to perform one or more elements of a method described in or related to any of examples 1-27, or any other method or process described herein.

Another example may include a method, technique, or process as described in or related to any of examples 1-27, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-27, or portions thereof.

Another example may include a signal as described in or related to any of examples 1-27, or portions or parts thereof.

Another example may include a datagram, information element, packet, frame, segment, PDU, or message as described in or related to any of examples 1-27, or portions or parts thereof, or otherwise described in the present disclosure.

Another example may include a signal encoded with data as described in or related to any of examples 1-27, or portions or parts thereof, or otherwise described in the present disclosure.

Another example may include a signal encoded with a datagram, IE, packet, frame, segment, PDU, or message as described in or related to any of examples 1-27, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Another example may include a computer program comprising instructions, wherein execution of the program by a processing element is to cause the processing element to carry out the method, techniques, or process as described in or related to any of examples 1-27, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples) unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a radio resource control (RRC) configuration including a channel state information (CSI)-report configuration associated with a layer 1 (L1) cross link interference (CLI)-received signal strength indicator (RSSI) measurement and a CLI-RSSI report;
processing a reference resource based on the RRC configuration for the L1 CLI-RSSI measurement; and
generating the CLI-RSSI report based on the L1 CLI-RSSI measurement.

2. The method of claim 1, wherein the reference resource is configured as a channel measurement resource (CMR) based on a resource-for-channel-measurement (resourceForChannelMeasurement) field in the CSI-report configuration.

3. The method of claim 1, wherein the reference resource is associated with an RSSI-resource configuration CLI information element (IE).

4. The method of claim 3, wherein the reference resource is associated with the RSSI-resource configuration CLI IE, and the RRC configuration includes a CSI-resource configuration associated with configuration of the RSSI-resource configuration CLI IE, the RSSI-resource configuration CLI IE includes an indication of a serving cell, and the method further comprises:
measuring an RSSI based on an active bandwidth part associated with the serving cell.

5. The method of claim 3, wherein the reference resource is associated with the RSSI-resource configuration CLI IE, the RRC configuration includes a CSI-associated-report-configuration-information IE that includes:
an index associated with the RSSI-resource configuration CLI IE; or
quasi colocation (QCL) information associated with a reception of the reference resources.

6. The method of claim 1, wherein the CSI-report configuration includes a report quantity field associated with a CSI report, the report quantity field indicating the CSI report includes the CLI-RSSI report.

7. An apparatus comprising:
processing circuitry to:
process a radio resource control (RRC) configuration including a channel state information (CSI)-report configuration associated with a layer 1 (L1) cross link interference (CLI)-received signal strength indicator (RSSI) measurement and a CLI-RSSI report;
process a reference resource based on the RRC configuration for the L1 CLI-RSSI measurement; and
generate the CLI-RSSI report based on the L1 CLI-RSSI measurement; and
interface circuitry coupled with the processing circuitry to enable communication.

8. The apparatus of claim 7, wherein the reference resource is associated with a non-zero-power (NZP)-CSI-reference signal (RS)-resource IE.

9. A method comprising:
processing a radio resource control (RRC) configuration received from a base station, the RRC configuration including:
a cross link interference (CLI)-received signal strength indicator (RSSI) resource configuration; and
a channel state information (CSI) resource configuration having:
a CSI reference signal (RS) resource set list including a CSI-RS resource set identifier; and
a CLI-RSSI resource list associated with the CLI-RSSI resource configuration;
performing a measurement based on the CSI resource configuration to determine a CLI-RSSI; and
generating a report, to be transmitted to the base station, based on the CLI-RSSI.

10. The method of claim 9, wherein the CLI-RSSI resource configuration is an RSSI-ResourceConfigCLI configuration or a non-zero-power (NZP)-CSI-RS-ResourceSet.

11. The method of claim 9, wherein the CSI resource configuration includes a bandwidth part identifier associated with a bandwidth part, and the method further comprises:
processing an indication associated with an active bandwidth part; and
wherein said performing the measurement further comprises:
performing the measurement based on the active bandwidth part.

12. The method of claim 9, wherein the RRC configuration includes a CSI associated report configuration information having:
a first indicator associated with a non-zero-power (NZP) CSI-RS configuration; and
a second indicator associated with a CLI-RSSI configuration including an indication of CLI-RSSI resources or quasi-colocation information.

13. The method of claim 9, wherein the RRC configuration includes a time restriction for channel measurement information having a configured value, and the method further comprises:
assigning a value of “CONFIGURED” to the configured value; and wherein said performing the measurement comprises:
performing the measurement based on the assigned value.

14. The method of claim 9, wherein the RRC configuration includes a time restriction for channel measurement information having a configured value, and the method further comprises:
determining that the configured value is “NOTCONFIGURED”;
processing an averaging window configuration received from the base station;
determining an averaging window associated with the measurement based on the averaging window configuration; and wherein said performing the measurement further comprises:
performing the measurement based on the averaging window configuration.

15. The method of claim 9, wherein the RRC configuration includes a CSI report configuration having a report quantity field indicating that the CLI-RSSI is to be measured and reported.

16. The method of claim 9, wherein a priority of the report is equal to a priority of a beam management (BM) CSI report, or a priority of the report is equal to a priority of a link adaptation (LA) CSI report.

17. The method of claim 9, wherein:
the report is a periodic report or a semi-persistent report; and
a total CLI-RSSI resource configuration only includes the CLI-RSSI resource configuration and a minimum CLI-RSSI processing time is 4 milliseconds (ms), or
the CLI-RSSI resource configuration is a first CLI-RSSI resource configuration, a total CLI-RSSI resource configuration includes the first CLI-RSSI resource configuration and a second CLI-RSSI resource configuration, and a minimum CLI-RSSI processing time is 5 (ms).

18. The method of claim 9, wherein the report is an aperiodic report, and the method further comprises:
processing a trigger received from the base station to initiate the measurement, wherein a first period, indicating a first time between a reception of the trigger and the measurement, is smaller than a first threshold or a second period, indicating a second time between a reception of the trigger and a transmission of the report, is smaller than a second threshold.

19. The method of claim 9, further comprising:
generating a capability report, to be sent to the base station, including an indication of a number of CSI processing units associated with a number of CLI-RSSIs that the UE is capable of generating concurrently.

20. The method of claim 9, further comprising:
determining a number of CSI processing unit, based on a number of configured CLI-RSSI resources.
